(19) United States
(12) Patent Application Publication
(10) Pub. No.: US 2004/0081070 A1
(43) Pub. Date: Apr. 29, 2004

(54) CD& DVD medium outter protector ring

(76) Inventor: Jose Alfonso Correa, Lake Worth, FL (US)

Correspondence Address: Jose Alfonso Correa, 302 Lake Osborne Dr. Apt# 17, Lake Worth, FL, 33461, US

(21) Appl. No.: 10/277,780

(22) Filed: Oct. 23, 2002

(51) Int. Cl. G11B 3/70; G11B 5/84; G11B 7/26

(52) U.S. Cl. 369/280; 369/291

(57) ABSTRACT

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### CROSS REFERENCES TO RELATED APPLICATIONS

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### BACKGROUND—FIELD OF INVENTION

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### BACKGROUND—DESCRIPTION OF PRIOR ART

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### OBJECTS AND ADVANTAGES

Accordingly, several objects and advantages of my invention are my invention of the CD & DVD medium outter protection ring will prevent the data containing side of the medium from getting damaged from friction to a surface where it may be placed on.

Still further objects and advantages will become apparent from a consideration of the ensuing description and accompanying drawings.

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### BRIEF DESCRIPTION OF THE DRAWINGS

FIG. 1 shows top view of CD & DVD medium

FIG. 2 shows side view of CD & DVD medium

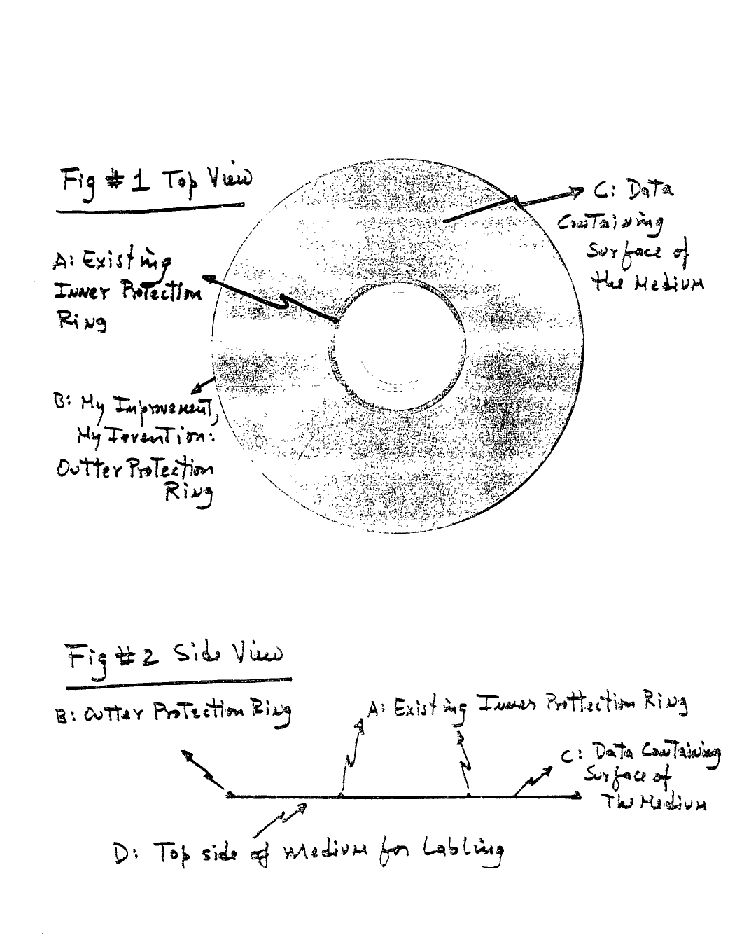

### REFERENCE NUMERALS

Numerals

### SUMMARY

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### PREFERRED EMBODIMENT—DESCRIPTION

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### PREFERRED EMBODIMENT—OPERATION

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

### OTHER EMBODIMENTS

CD & DVD Medium Protection Ring—Description

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

CD & DVD Medium Protection Ring—Operation

This invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

Conclusions, Ramifications, and Scope

Accordingly, it can be seen that *my invention is a technical inprovement of the CD & DVD medium. It involves the addition of a protective ring on the outside border of a CD & DVD to prevent the face of the CD & DVD containing the data from touching a surface where it may be placed on.

Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.

My invention of the CD & DVD medium outter protection ring will prevent the data containing side of the medium from getting damaged from friction to a surface where it may be placed on.

Although the description above contains many specificities, theses should not be construed as limiting the scope of the invention but as merely providing illustrations of some of the presently preferred embodiments of this invention. Various other embodiments and ramifications are possible within it's scope. Ramifications: my invention can be used in any data storage medium simmilar to a CD or DVD.

Thus the scope of the invention should be determined by the appended claims and their legal equivalents, rather than by the examples given.

What is claimed is:

1. This invention is a technical inprovement of the CD & DVD medium. It involves the addition of a protective ring on the outside border of a CD & DVD to prevent the face of the CD & DVD containing the data from touching a surface where it may be placed on.
Currently CD & DVD's only have one ring on the inner part of the CD & DVD medium to prevent the CD & DVD from touching each other while packed. I propose the addition of a simmilar ring on the outter edge of the CD & DVD medium to further prevent contact of the CD & DVD surface containing the data with any surface it may be placed on.
My invention of the CD & DVD medium outter protection ring will prevent the data containing side of the medium from getting damaged from friction to a surface where it may be placed on.
